(19) United States
(12) Patent Application Publication
(10) Pub. No.: US 2026/0131722 A1
(43) Pub. Date: May 14, 2026

(54) LAMP CONTROL SYSTEM, LAMP CONTROL METHOD, AND VEHICLE

(71) Applicant: HYUNDAI MOBIS CO., LTD., Seoul (KR)

(72) Inventor: Jun Young SUNG, Yongin-si (KR)

(73) Assignee: HYUNDAI MOBIS CO., LTD., Seoul (KR)

(21) Appl. No.: 19/308,906

(22) Filed: Aug. 25, 2025

(30) Foreign Application Priority Data
Nov. 8, 2024 (KR) 10-2024-0158349
Nov. 8, 2024 (KR) 10-2024-0158350

(51) Int. Cl. B60Q 1/14

(52) U.S. Cl. CPC B60Q 1/143; B60Q 2300/114; B60Q 2300/142; B60Q 2300/338; B60Q 2300/41

(57) ABSTRACT

A lamp control system for a moving object, and a lamp control method therefor are provided. The lamp control system includes a lamp to emit a beam pattern, among a plurality of beam patterns, toward a front of the moving object, a memory for storing location-based driving data or data obtained by analyzing and refining the location-based driving data, and a processor to control the beam pattern based on the data stored in the memory and location information of the moving object.

### CROSS-REFERENCE TO RELATED APPLICATION(S)

Pursuant to 35 U.S.C. § 119(a), this application claims the benefit of earlier filing dates and right of priority to Korean Application Nos. 10-2024-0158349 and 10-2024-0158350, filed on Nov. 8, 2024, in the Korean Intellectual Property Office the contents of which are hereby incorporated by reference herein in their entirety for all purposes.

### BACKGROUND

### 1. Field

The present disclosure relates to a lamp control system, a lamp control method, and a vehicle, and more particularly, to a lamp control system, a lamp control method, and a vehicle that utilize driving data corresponding to location information.

### 2. Description of the Related Art

As utilization of light-emitting diode (LED) light sources in vehicle lamps continues to increase, the number of high beam and low beam vehicle lamp modules with various performances has increased. In particular, a trend toward integration of high-low beam vehicle modules has been established, and these have received considerable attention in the market due to their low cost, small size, simple structure, and comprehensive functionality.

As interest of people in safety while driving increases, a considerable number of driving accidents occur every year due to inappropriate use of high beams. A vehicle lamp module with an intelligent front-lighting system (IFS) function may resolve contradiction of high-low beam use to some extent. That is, The vehicle lamp module provides excellent visibility to the vehicle and prevent glare to other drivers. The IFS function has a kind of smart control performance, which may control a lighting area and lighting brightness in real time by independently controlling each LED, effectively preventing glare to other vehicles and pedestrians.

In the existing vehicle with the IFS function, a driver directly specifies a speed at which the IFS function is activated, and the IFS function is automatically activated when the vehicle is driven above the corresponding speed. However, the existing method has a problem in that a lighting is controlled without considering an environment of a road on which the vehicle drives, resulting in the lighting being dimmed on relatively dark roads or being brighter in relatively bright places, obstructing a view of pedestrians or other drivers. The IFS function may be activated earlier than the driver wants, which may result in many malfunctions due to camera recognition errors, or the ADB function may be activated later than the driver wants, which may cause frustration.

There are frequent cases in which drivers are not aware of the IFS function even though the vehicle is equipped with the IFS function and thus do not use the IFS function. Therefore, a method is needed to automatically activate the IFS function according to a surrounding road environment and driver preferences.

### SUMMARY

The present disclosure proposes a lamp control system configured to control a lamp by using driving data, a vehicle including the lamp control system, or a method therefor.

The present disclosure proposes a lamp control system configured to control a beam pattern according to a data-based lane change frequency in performing lamp control, a vehicle including the lamp control system, or a method therefor.

The present disclosure proposes a lamp control system configured to control a beam pattern according to a driving data-based sudden braking frequency in performing lamp control, a vehicle including the lamp control system, or a method therefor.

The present disclosure proposes a lamp control system configured to detect whether a passing beam is used based on driving data when performing lamp control and control a beam pattern accordingly, a vehicle including the lamp control system, or a method therefor.

The objects of the present disclosure are not limited to the objects described above. Other objects not described above may be understood by those skilled in the art from the description of the present disclosure below.

In a general aspect, a lamp control system for a moving object, includes: a lamp configured to emit a beam pattern, among a plurality of beam patterns, toward a front of the moving object; a memory for storing location-based driving data or data obtained by analyzing and refining the location-based driving data; and a processor configured to control the beam pattern based on the data stored in the memory and location information of the moving object.

The processor may be further configured to control the lamp to strengthen a beam width of the beam pattern based on a lane change frequency of the driving data corresponding to the location information of the moving object exceeding a preset reference.

The processor may be further configured to emit a beam pattern having a beam width that increases in proportion to the lane change frequency.

The processor may be further configured to control the lamp to reduce a beam width of the beam pattern based on a lane change frequency of the driving data corresponding to the location information of the moving object being lower than a preset reference.

The processor may be further configured to control the lamp to strengthen a beam distance or a beam width of the beam pattern based on a sudden braking frequency of the driving data corresponding to the location information of the moving object exceeding a preset reference.

The processor may be further configured to emit a beam pattern having a beam distance or a beam width that increases in proportion to the sudden braking frequency.

The processor may be further configured to determine whether the moving object intends to overtake a preceding vehicle based on driving data of the moving object, and control the lamp to emit a specific beam pattern based on location-based usage history data of the specific beam pattern and the location information of the moving object.

The processor may be further configured to control the lamp to emit a beam pattern having a beam distance or a beam width that increases in proportion to a frequency of usage of the specific beam patten.

The data may be obtained by analyzing and refining the location-based driving data or the driving data includes data obtained by collecting and processing data on a lane change frequency on a separate road segment, a sudden braking frequency on the separate road segment, or a frequency of use of a specific beam pattern on the separate road segment of a plurality of moving objects based on information on the separate road segment or location information.

The processor may be further configured to additionally use at least one of navigation information, advanced driver assistance system related information, or vehicle control output interface information, for controlling the beam pattern.

In another general aspect, a lamp control system for a moving object, includes: a lamp configured to emit a beam pattern, among a plurality of beam patterns, toward a front of the moving object; a memory for storing data obtained by analyzing and refining location-based usage history data of a specific beam pattern or usage history data of the specific beam pattern; and a processor configured to control the beam pattern based on the data stored in the memory and location information of the moving object.

The processor may be further configured to activate an adaptive lamp mode based on a frequency of lighting of the specific beam pattern corresponding to the location information of the moving object indicated by the data exceeding a preset reference.

The processor may be further configured to emit a beam pattern having a central brightness that increases in proportion to the frequency of lighting.

The processor may be further configured to deactivate the adaptive lamp mode, change an operating mode of the lamp, or change a parameter of the adaptive lamp mode based on a frequency of turning off the specific beam pattern corresponding to the location information of the moving object indicated by the data exceeding a preset reference.

The operating mode of the lamp may include a high beam assistance mode or a low beam mode.

The processor may be further configured to average and calculate a result of recognition or non-recognition of a tail lamp of a preceding vehicle over a preset period of time through a camera of the moving object.

The processor may be further configured to control the lamp according to the result of recognition or non-recognition of the tail lamp of the preceding vehicle.

The location-based usage history data of the specific beam pattern may include data linked to operation information of a stalk for lighting the specific beam pattern and location information of a navigation of a plurality of moving objects.

The data obtained by analyzing and refining the location-based usage history data of the specific beam pattern may include big data obtained by collecting and analyzing a usage history of the specific beam pattern of a plurality of moving objects based on location information.

In yet another general aspect, a lamp control method for a moving object, performed by a lamp control system including a lamp configured to emit a beam pattern toward a front of the moving object, the lamp control method including: obtaining location information of the moving object; extracting data obtained from location-based driving data or by analyzing and refining the location-based driving data; and controlling the beam pattern based on the extracted data and location information of the moving object.

The solution of the present disclosure described above is a part of the embodiments of the present disclosure. Various solution means other than the solution of the problem described above may be derived and understood based on the detailed description of the present disclosure to be described below.

### BRIEF DESCRIPTION OF THE DRAWINGS

The present disclosure will become more fully understood from the detailed description given herein below and the accompanying drawings, which are given by illustration only, and thus are not limitative of the present disclosure.

FIG. 1 is an overall block diagram of an autonomous driving vehicle to which an autonomous driving apparatus is applicable.

FIG. 2 is a diagram illustrating an example in which an autonomous driving apparatus is applied to a vehicle.

FIG. 3 is a block diagram of a lamp control system according to the present disclosure.

FIG. 4 illustrates data obtained by collecting and analyzing a usage history of a specific beam pattern of a plurality of moving objects based on location information according to the present disclosure.

FIG. 5 illustrates a flowchart of a lamp control method according to the present disclosure.

FIG. 6 illustrates an example of a beam pattern with a controlled beam width according to the present disclosure.

FIG. 7 illustrates a flowchart of a lamp control method according to the present disclosure.

FIG. 8 illustrates an example of a beam pattern with controlled beam distance and beam width according to the present disclosure.

FIG. 9 illustrates a flowchart of a lamp control method according to the present disclosure.

FIG. 10 illustrates a flowchart of a lamp control method according to the present disclosure.

FIG. 11 illustrates an example of a beam pattern with controlled central brightness according to the present disclosure.

FIG. 12 illustrates a flowchart of a lamp control method according to the present disclosure.

FIG. 13 illustrates a beam cutting phenomenon.

FIG. 14 shows an existing lamp control signal based on a flicker phenomenon and a lamp control signal according to the present disclosure.

### DETAILED DESCRIPTION

Hereinafter, embodiments of the present disclosure will be described in detail with reference to the accompanying drawings so that the present disclosure may be easily realized by those skilled in the art. However, the present disclosure may be achieved in various different forms and is not limited to the embodiments described herein. In the drawings, parts that are not related to a description of the present disclosure are omitted to clearly explain the present disclosure and similar reference numbers will be used throughout this specification to refer to similar parts.

In the specification, when a part “includes” an element, it means that the part may further include another element rather than excluding another element unless otherwise mentioned.

In addition, in the specification, “occupant”, “passenger”, “driver”, “user”, etc. are mentioned for description of the present disclosure, and may be used interchangeably therewith.

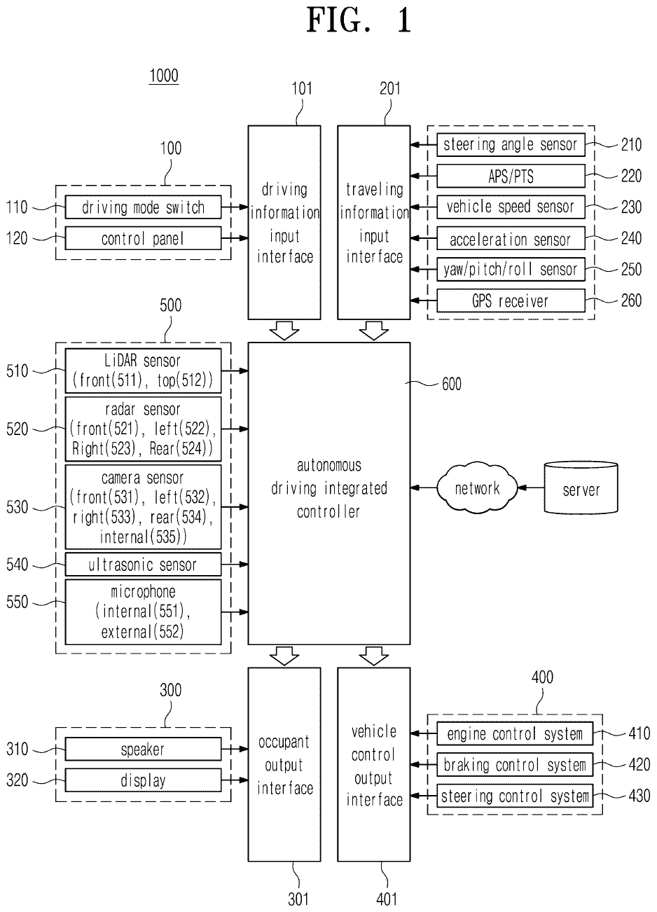

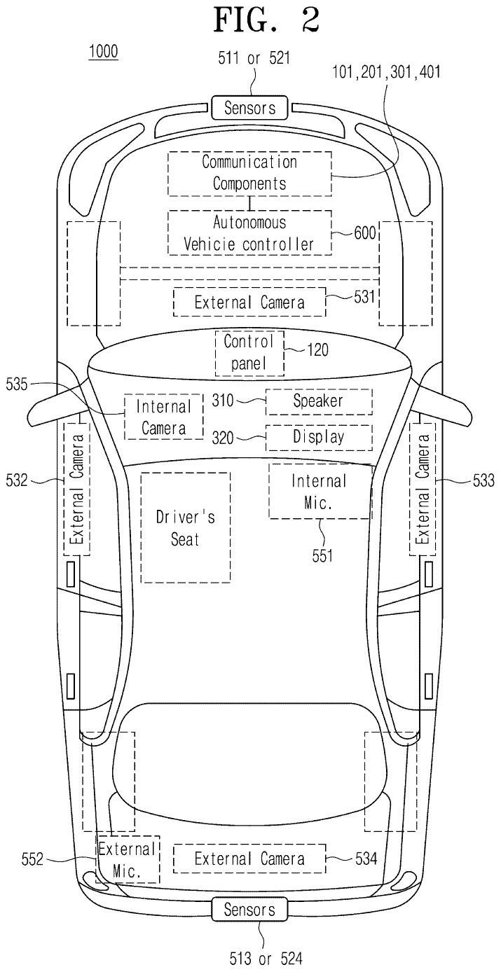

FIG. 1 is an overall block diagram of an autonomous driving control system to which an autonomous driving apparatus according to any one of embodiments of the present disclosure is applicable. FIG. 2 is a diagram illustrating an example in which an autonomous driving apparatus according to any one of embodiments of the present disclosure is applied to a vehicle.

First, a structure and function of an autonomous driving control system (e.g., an autonomous driving vehicle) to which an autonomous driving apparatus according to the present embodiments is applicable will be described with reference to FIGS. 1 and 2.

As illustrated in FIG. 1, an autonomous driving vehicle 1000 may be implemented based on an autonomous driving integrated controller 600 that transmits and receives data necessary for autonomous driving control of a vehicle through a driving information input interface 101, a traveling information input interface 201, an occupant output interface 301, and a vehicle control output interface 401. However, the autonomous driving integrated controller 600 may also be referred to herein as a controller, a processor, or, simply, a controller.

The autonomous driving integrated controller 600 may obtain, through the driving information input interface 101, driving information based on manipulation of an occupant for a user input unit 100 in an autonomous driving mode or manual driving mode of a vehicle. As illustrated in FIG. 1, the user input unit 100 may include a driving mode switch 110 and a control panel 120 (e.g., a navigation terminal mounted on the vehicle or a smartphone or tablet computer owned by the occupant). Accordingly, driving information may include driving mode information and navigation information of a vehicle.

For example, a driving mode (i.e., an autonomous driving mode/manual driving mode or a sports mode/eco mode/safety mode/normal mode) of the vehicle determined by manipulation of the occupant for the driving mode switch 110 may be transmitted to the autonomous driving integrated controller 600 through the driving information input interface 101 as the driving information.

Furthermore, navigation information, such as the destination of the occupant input through the control panel 120 and a path up to the destination (e.g., the shortest path or preference path, selected by the occupant, among candidate paths up to the destination), may be transmitted to the autonomous driving integrated controller 600 through the driving information input interface 101 as the driving information.

The control panel 120 may be implemented as a touchscreen panel that provides a user interface (UI) through which the occupant inputs or modifies information for autonomous driving control of the vehicle. In this case, the driving mode switch 110 may be implemented as touch buttons on the control panel 120.

In addition, the autonomous driving integrated controller 600 may obtain traveling information indicative of a driving state of the vehicle through the traveling information input interface 201. The traveling information may include a steering angle formed when the occupant manipulates a steering wheel, an accelerator pedal stroke or brake pedal stroke formed when the occupant depresses an accelerator pedal or brake pedal, and various types of information indicative of driving states and behaviors of the vehicle, such as a vehicle speed, acceleration, a yaw, a pitch, and a roll formed in the vehicle. The traveling information may be detected by a traveling information detection unit 200, including a steering angle sensor 210, an accelerator position sensor (APS)/pedal travel sensor (PTS) 220, a vehicle speed sensor 230, an acceleration sensor 240, and a yaw/pitch/roll sensor 250, as illustrated in FIG. 1.

Furthermore, the traveling information of the vehicle may include location information of the vehicle. The location information of the vehicle may be obtained through a global positioning system (GPS) receiver 260 applied to the vehicle. Such traveling information may be transmitted to the autonomous driving integrated controller 600 through the traveling information input interface 201 and may be used to control the driving of the vehicle in the autonomous driving mode or manual driving mode of the vehicle.

The autonomous driving integrated controller 600 may transmit driving state information provided to the occupant to an output unit 300 through the occupant output interface 301 in the autonomous driving mode or manual driving mode of the vehicle. That is, the autonomous driving integrated controller 600 transmits the driving state information of the vehicle to the output unit 300 so that the occupant may check the autonomous driving state or manual driving state of the vehicle based on the driving state information output through the output unit 300. The driving state information may include various types of information indicative of driving states of the vehicle, such as a current driving mode, transmission range, and speed of the vehicle.

If it is determined that it is necessary to warn a driver in the autonomous driving mode or manual driving mode of the vehicle along with the above driving state information, the autonomous driving integrated controller 600 transmits warning information to the output unit 300 through the occupant output interface 301 so that the output unit 300 may output a warning to the driver. In order to output such driving state information and warning information acoustically and visually, the output unit 300 may include a speaker 310 and a display 320 as illustrated in FIG. 1. In this case, the display 320 may be implemented as the same device as the control panel 120 or may be implemented as an independent device separated from the control panel 120.

Furthermore, the autonomous driving integrated controller 600 may transmit control information for driving control of the vehicle to a lower control system 400, applied to the vehicle, through the vehicle control output interface 401 in the autonomous driving mode or manual driving mode of the vehicle. As illustrated in FIG. 1, the lower control system 400 for driving control of the vehicle may include an engine control system 410, a braking control system 420, and a steering control system 430. The autonomous driving integrated controller 600 may transmit engine control information, braking control information, and steering control information, as the control information, to the respective lower control systems 410, 420, and 430 through the vehicle control output interface 401. Accordingly, the engine control system 410 may control the speed and acceleration of the vehicle by increasing or decreasing fuel supplied to an engine. The braking control system 420 may control the braking of the vehicle by controlling braking power of the vehicle. The steering control system 430 may control the steering of the vehicle through a steering device (e.g., motor driven power steering (MDPS) system) applied to the vehicle.

As described above, the autonomous driving integrated controller 600 according to the present embodiment may obtain the driving information based on manipulation of the driver and the traveling information indicative of the driving state of the vehicle through the driving information input interface 101 and the traveling information input interface 201, respectively, and transmit the driving state information and the warning information, generated based on an autonomous driving algorithm, to the output unit 300 through the occupant output interface 301. In addition, the autonomous driving integrated controller 600 may transmit the control information generated based on the autonomous driving algorithm to the lower control system 400 through the vehicle control output interface 401 so that driving control of the vehicle is performed.

In order to guarantee stable autonomous driving of the vehicle, it is necessary to continuously monitor the driving state of the vehicle by accurately measuring a driving environment of the vehicle and to control driving based on the measured driving environment. To this end, as illustrated in FIG. 1, the autonomous driving apparatus according to the present embodiment may include a sensor unit 500 for detecting a nearby object of the vehicle, such as a nearby vehicle, pedestrian, road, or fixed facility (e.g., a signal light, a signpost, a traffic sign, or a construction fence).

The sensor unit 500 may include one or more of a LIDAR sensor 510, a radar sensor 520, or a camera sensor 530, in order to detect a nearby object outside the vehicle, as illustrated in FIG. 1.

The LiDAR sensor 510 may transmit a laser signal to the periphery of the vehicle and detect a nearby object outside the vehicle by receiving a signal reflected and returning from a corresponding object. The LiDAR sensor 510 may detect a nearby object located within the ranges of a preset distance, a preset vertical field of view, and a preset horizontal field of view, which are predefined depending on specifications thereof. The LiDAR sensor 510 may include a front LiDAR sensor 511, a top LiDAR sensor 512, and a rear LiDAR sensor 513 installed at the front, top, and rear of the vehicle, respectively, but the installation location of each LiDAR sensor and the number of LiDAR sensors installed are not limited to a specific embodiment. A threshold for determining the validity of a laser signal reflected and returning from a corresponding object may be previously stored in a memory (not illustrated) of the autonomous driving integrated controller 600. The autonomous driving integrated controller 600 may determine a location (including a distance to a corresponding object), speed, and moving direction of the corresponding object using a method of measuring time taken for a laser signal, transmitted through the LiDAR sensor 510, to be reflected and returning from the corresponding object.

The radar sensor 520 may radiate electromagnetic waves around the vehicle and detect a nearby object outside the vehicle by receiving a signal reflected and returning from a corresponding object. The radar sensor 520 may detect a nearby object within the ranges of a preset distance, a preset vertical field of view, and a preset horizontal field of view, which are predefined depending on specifications thereof. The radar sensor 520 may include a front radar sensor 521, a left radar sensor 522, a right radar sensor 523, and a rear radar sensor 524 installed at the front, left, right, and rear of the vehicle, respectively, but the installation location of each radar sensor and the number of radar sensors installed are not limited to a specific embodiment. The autonomous driving integrated controller 600 may determine a location (including a distance to a corresponding object), speed, and moving direction of the corresponding object using a method of analyzing power of electromagnetic waves transmitted and received through the radar sensor 520.

The camera sensor 530 may detect a nearby object outside the vehicle by photographing the periphery of the vehicle and detect a nearby object within the ranges of a preset distance, a preset vertical field of view, and a preset horizontal field of view, which are predefined depending on specifications thereof.

The camera sensor 530 may include a front camera sensor 531, a left camera sensor 532, a right camera sensor 533, and a rear camera sensor 534 installed at the front, left, right, and rear of the vehicle, respectively, but the installation location of each camera sensor and the number of camera sensors installed are not limited to a specific embodiment. The autonomous driving integrated controller 600 may determine a location (including a distance to a corresponding object), speed, and moving direction of the corresponding object by applying predefined image processing to an image captured by the camera sensor 530.

In addition, an internal camera sensor 535 for capturing the inside of the vehicle may be mounted at a predetermined location (e.g., rear view mirror) within the vehicle. The autonomous driving integrated controller 600 may monitor a behavior and state of the occupant based on an image captured by the internal camera sensor 535 and output guidance or a warning to the occupant through the output unit 300.

As illustrated in FIG. 1, the sensor unit 500 may further include an ultrasonic sensor 540 in addition to the LiDAR sensor 510, the radar sensor 520, and the camera sensor 530 and further adopt various types of sensors for detecting a nearby object of the vehicle along with the sensors.

FIG. 2 illustrates an example in which, in order to aid in understanding the present embodiment, the front LiDAR sensor 511 or the front radar sensor 521 is installed at the front of the vehicle, the rear LiDAR sensor 513 or the rear radar sensor 524 is installed at the rear of the vehicle, and the front camera sensor 531, the left camera sensor 532, the right camera sensor 533, and the rear camera sensor 534 are installed at the front, left, right, and rear of the vehicle, respectively. However, as described above, the installation location of each sensor and the number of sensors installed are not limited to a specific embodiment.

Furthermore, in order to determine a state of the occupant within the vehicle, the sensor unit 500 may further include a bio sensor for detecting bio signals (e.g., heart rate, electrocardiogram, respiration, blood pressure, body temperature, electroencephalogram, photoplethysmography (or pulse wave), and blood sugar) of the occupant. The bio sensor may include a heart rate sensor, an electrocardiogram sensor, a respiration sensor, a blood pressure sensor, a body temperature sensor, an electroencephalogram sensor, a photoplethysmography sensor, and a blood sugar sensor.

Finally, the sensor unit 500 additionally includes a microphone 550 having an internal microphone 551 and an external microphone 552 used for different purposes.

The internal microphone 551 may be used, for example, to analyze the voice of the occupant in the autonomous driving vehicle 1000 based on AI or to immediately respond to a direct voice command of the occupant.

In contrast, the external microphone 552 may be used, for example, to appropriately respond to safe driving by analyzing various sounds generated from the outside of the autonomous driving vehicle 1000 using various analysis tools such as deep learning.

For reference, the symbols illustrated in FIG. 2 may perform the same or similar functions as those illustrated in FIG. 1. FIG. 2 illustrates in more detail a relative positional relationship of each component (based on the interior of the autonomous driving vehicle 1000) as compared with FIG. 1.

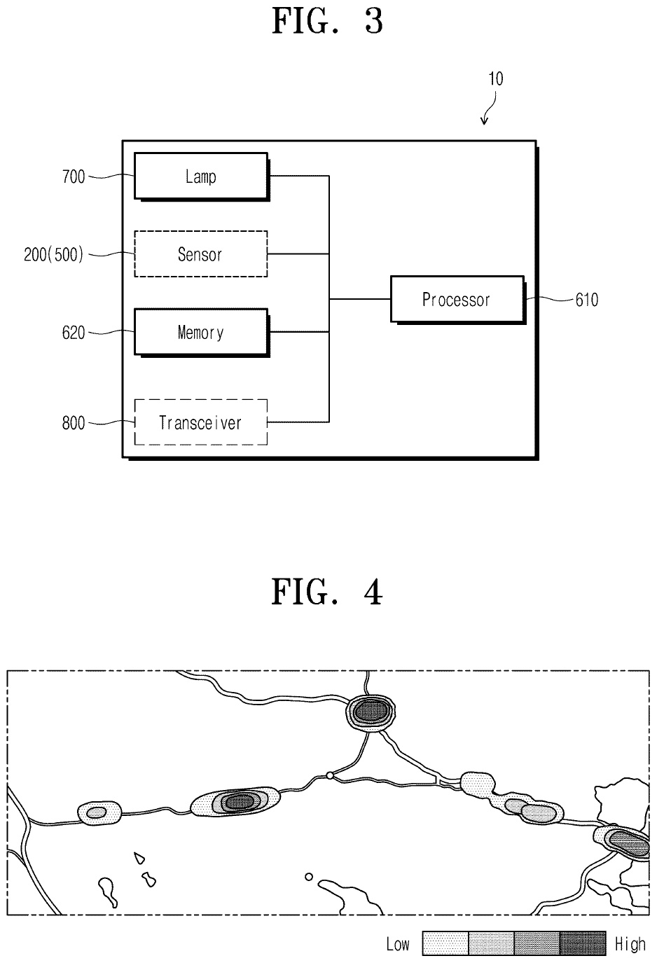

FIG. 3 is a block diagram of a lamp control system according to the present disclosure.

A lamp control system 10 may include a lamp 700, memory 620, and a processor 610. The lamp control system 10 may be included in a moving object 1000 and may be mounted or installed in the moving object 1000. In this specification, the moving object means an object that has mobility as a transportation, and may include, for example, a vehicle, a drone, and a robot.

The lamp 700 is a type of output unit that emits a beam in a front direction of a moving object according to a beam pattern and may be formed in a pair. In more detail, the lamp 700 may include a pair of headlamps on a left front and right front based on the moving object (or vehicle). In general, a headlamp or a headlight may include a low beam, a high beam, a turn signal, a daytime driving light, and a side light.

The memory 620 may store location-based driving data. Additionally or alternatively, the memory 620 may store data refined by analyzing the driving data. Here, the driving data may include information about a frequency of lane changes on separate road segments for a plurality of moving objects, a frequency of sudden braking on separate road segments, or a frequency of use of a specific beam pattern on separate road segments. That is, the driving data may include information obtained by collecting lane change information, sudden braking information, or usage information of a specific beam pattern of moving objects passing through the corresponding road segment for the separate road segment and digitizing and processing the collected information.

Before this, the lamp control system 10 may be configured to receive location-based driving data from a server.

The location-based driving data may include information connected to location information that may infer lane change or sudden braking information of the plurality of moving objects. That is, the server may collect and store, analyze, process, or manage navigation information of moving objects driving on separate road segments or GPS information of moving objects related thereto, information related to an advanced driver assistance system (ADAS) of moving objects, or output interface information for vehicle control of moving objects.

The navigation information of moving objects or the GPS information of moving objects related thereto may indicate location information to be used to determine whether the moving object changes lanes. Accordingly, the server may analyze the navigation information of the moving objects or the GPS information of moving objects related thereto to extract lane change information or lane change frequency on separate road segments. The server may digitize the lane change information or the lane change frequency and represent the same as a refined number.

The navigation information of moving objects or the GPS information of moving objects related thereto may indicate location information to be used to determine whether the moving object suddenly stops. Accordingly, the server may analyze the navigation information of the moving objects or the GPS information of moving objects related thereto to extract sudden braking information or sudden braking frequency on separate road segments. The server may digitize the sudden braking information or the sudden braking frequency and represent the same as a refined number.

For example, the following data may be obtained.

TABLE 1

| | lane change frequency | sudden braking frequency |
|---|---|---|
| Road segment | (relative index) | (relative index) |
| RD1 | 90 | 61 |
| RD2 | 97 | 65 |
| RD3 | 7 | 10 |
| RD4 | 15 | 19 |
| . . . | . . . | . . . |

As another piece of information, ADAS-related information of moving objects may indicate driving control information (such as acceleration, steering or braking) for the moving object to determine whether the moving object changes lanes, and ADAS-related information may be linked with location information. Therefore, the server may analyze the ADAS-related information of moving objects to extract driving control information (such as acceleration, steering, or braking) for separate road segments.

Accordingly, the server may extract lane change information or lane change frequency from the driving control information. The server may digitize the lane change information or the lane change frequency and represent the same as a refined number.

The server may extract sudden braking information or sudden braking frequency from the driving control information. The server may digitize the sudden braking information or the sudden braking frequency and represent the same as a refined number.

As another piece of information, output interface information for controlling the moving objects (or vehicles) of the moving objects may indicate engine control information, braking control information, and steering control information of the moving objects that may determine whether the moving objects change lanes, and the output interface information for controlling the moving objects (or vehicles) may be linked with location information. When a moving object obtains propulsion by using an electric motor, it is obvious that motor control information is used instead of engine control information.

Accordingly, the server may analyze output interface information for moving object control of moving objects to extract engine control information, braking control information, and steering control information for separate road segments.

Accordingly, the server may extract the lane change information or the lane change frequency from the engine control information, the braking control information, and the steering control information. The server may digitize the lane change information or the lane change frequency and represent the same as a refined number.

Accordingly, the server may extract the steering control information or the sudden braking frequency from the engine control information, the braking control information, and the steering control information. The server may digitize the sudden braking information or the sudden braking frequency and represent the same as a refined number.

The location-based driving data may include data linked to an output control signal of a manipulator or a stalk (e.g., a multi-function switch) for lighting a specific beam pattern (e.g., high beam) of a plurality of moving objects and location information of the moving object.

That is, the server may collect and store or manage an output control signal for a manipulator or a stalk such as a multi-function switch for lighting a specific beam pattern of a plurality of moving objects and location information at a time when the output control signal obtained by a location information obtaining device such as a navigation (or GPS receiver) is detected.

The server may analyze input control signals for the manipulator or the stalk such as a multi-function switch for lighting specific beam patterns of moving objects or location information of moving objects related thereto to extract usage information of specific beam patterns or a frequency of use of specific beam patterns on separate road segments. The server may digitize the usage information of the specific beam patterns or the frequency of use of specific beam patterns and indicate the same as a refined number.

The specific beam pattern may be combined with additional information. For example, if a specific beam pattern is high beam, when the information is combined with lane change information or acceleration information of a moving object, the information may be processed into information indicating use of a passing beam when overtaking a preceding vehicle or passing beam usage information may be extracted.

For example, by combining high beam lighting information, lane change information, braking information, or acceleration information on separate road segments, passing beam usage information on separate road segments may be obtained.

For example, the following data may be obtained.

TABLE 2

| | Passing beam usage |
|---|---|
| Road segment | frequency (relative Index) |
| RD1 | 10 |
| RD2 | 17 |
| RD3 | 53 |
| RD4 | 22 |
| . . . | . . . |

An example of big data regarding lane changes, sudden braking, and use of specific beam patterns based on location information according to the present disclosure is illustrated in FIG. 4.

As seen from FIG. 4, a frequency of lane changes, sudden braking, or a frequency of use (or lighting) of a specific beam pattern is indicated by hatching on a map. The information shown in FIG. 4 is obtained and indicated by collecting, analyzing, and refining one of a frequency of lane changes of a plurality of moving objects, a frequency of sudden braking, or a frequency of use of a specific beam pattern.

A region (location) in which moving objects perform or use lane changes, sudden braking, or specific beam patterns a lot (or frequently) may be understood as an area in which lane changes, sudden braking, or lighting of specific beam patterns is necessary due to a road condition, traffic volume, or the like. The present disclosure proposes to control a lamp (or control a beam pattern) corresponding to a lane change, sudden braking, or a location in which a specific beam pattern is frequently lighted even if a driver or user of the moving object does not separately operate lighting or control of the specific beam pattern.

The processor 610 may obtain location information of the moving object 1000. The location information of the moving object 1000 may be obtained by a sensor 200.

The processor 610 may be configured to control the lamp 700 by using location information of the moving object 1000 and location-based driving data stored in the memory 620. In more detail, the processor 610 may be configured to control a beam pattern emitted by the lamp 700.

The processor 610 may be configured to strengthen an optical width (i.e., beam width) of a beam pattern emitted by a lamp when a lane change frequency of driving data corresponding to the location information of the moving object 1000 indicated by the location-based driving data stored in the memory 620 exceeds a preset reference.

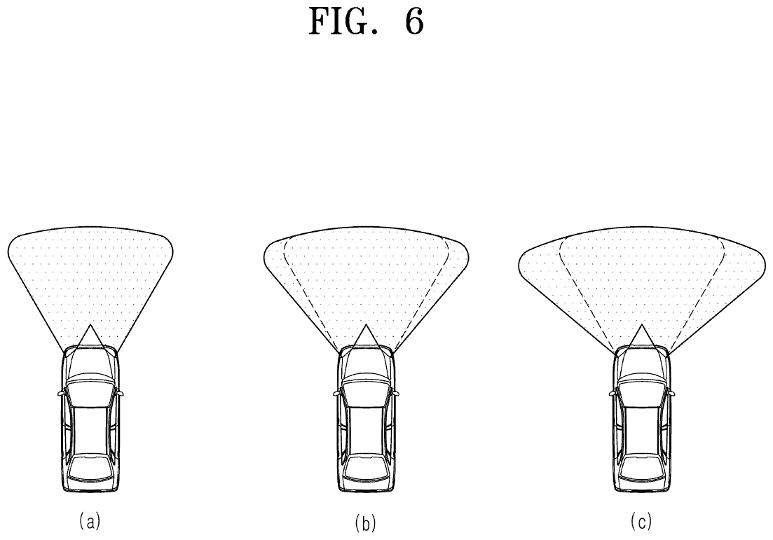

The processor 610 may control an beam width of a beam pattern to be strengthened more as a frequency of lane changes increases. In the order of (a), (b), and (c) of FIG. 6, the beam width of the beam pattern increases, and a frequency of lane changes increases in that order.

Here, the preset reference may be expressed as relative numbers representing, for example, a frequency of lane changes, a frequency of sudden braking, or a frequency of lighting a specific beam pattern (passing beam) for each separate road segment. As such, the processor 610 may be configured to strengthen an beam width of the beam pattern when a value of a frequency of lane changes, sudden braking, or frequency of lighting a specific beam pattern on a road segment in which the moving object 1000 is currently located exceeds a preset reference.

The processor 610 may be configured to reduce an beam width of a beam pattern emitted by a lamp when the lane change frequency of the location-based driving data corresponding to the location information of the moving object 1000 indicated by the driving data stored in the memory 620 exceeds a preset reference.

The processor 610 may be configured to strengthen an beam width of a beam pattern emitted by a lamp when a sudden braking frequency of driving data corresponding to the location information of the moving object 1000 indicated by the driving data stored in the memory 620 exceeds a preset reference.

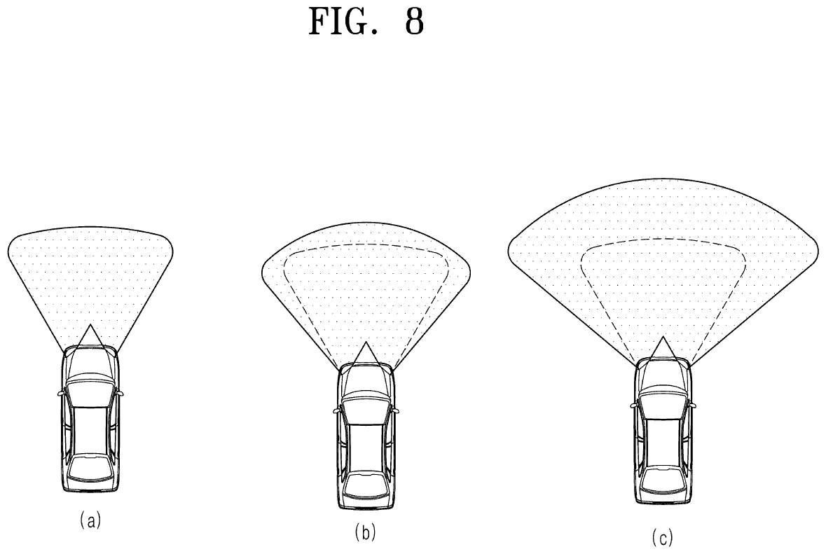

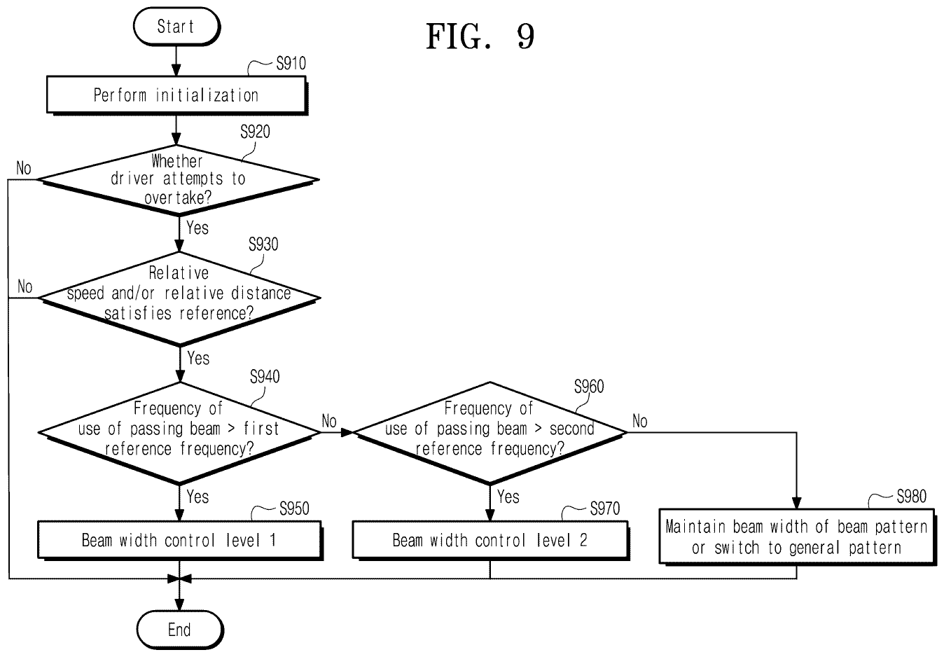

The processor 610 may control an beam width of a beam pattern to be strengthened more as a frequency of sudden braking increases. In the order of (a), (b), and (c) of FIG. 8, the beam width of the beam pattern increases, and a sudden braking frequency increases in that order.

The processor 610 may be configured to strengthen an beam width of a passing beam emitted by a lamp when a frequency of use of a specific beam pattern, for example, the passing beam corresponding to the location information of the moving object 1000 indicated by the location-based driving data stored in the memory 620 exceeds a preset reference.

The processor 610 may control an beam width of a beam pattern to be strengthened more as a frequency of use of the passing beam increases. In the order of (a), (b), and (c) of FIG. 8, the beam width of the beam pattern increases, and a frequency of use of a passing beam increases in that order.

The lamp control system 10 may further include a sensor 200 or 500. The sensor may include sensors 210, 220, 230, 240, 250, and 260 configured to obtain information related to driving of the moving object or sensors 510, 520, 530, and 540 configured to obtain surrounding information of the moving object. The current location information of the moving object 1000 may be obtained through the sensor. Location information of surrounding vehicles, such as a preceding vehicle or oncoming vehicle of the moving object 1000, may be obtained through the sensor.

The lamp control system 10 may further include a transceiver 800. The transceiver 800 may be configured to receive location-based driving data from the server. The transceiver 800 may be configured to transmit, to the server, the location-based driving data of the moving object 1000 on which the lamp control system 10 is mounted or installed.

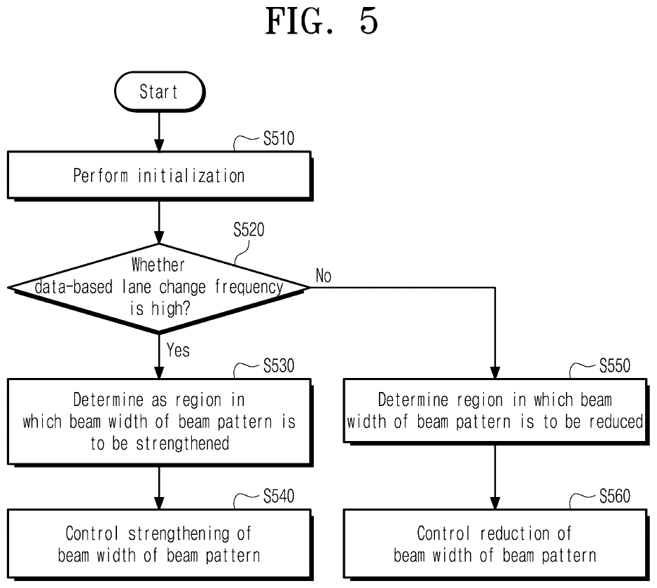

FIG. 5 illustrates a flowchart of a lamp control method according to the present disclosure. The illustrated lamp control method may be performed by a lamp control system 1 or the moving object 1000 including the lamp control system 1. For simplicity of explanation, the illustrated method will be described as being performed by the lamp control system 1.

The lamp control system 1 may be configured to perform initialization (S510). Initialization may include a procedure to check a system to ensure that the lamp control system operates properly.

The lamp control system 1 may be configured to determine whether data-based lane change frequency is relatively high in a region or location corresponding to the location information of the moving object 1000 (S520).

The location information of the moving object 1000 may be obtained by the sensor 200, and the data-based lane change frequency may be obtained from information on the lane change frequency in the separate road segment described above or data obtained from analyzing and refining the information.

Whether the frequency of lane changes in a separate road segment is relatively high may be determined by comparing the lane change frequency on a road segment corresponding to the location information of the moving object 1000 with the preset reference.

The data-based lane change frequency in a region or location corresponding to the location information of the moving object 1000 is relatively high, and thus the lamp control system 1 may be configured to determine that the location of the moving object 1000 is a region in which the beam width of the beam pattern is to be strengthened (S530).

Accordingly, the lamp control system 1 may be configured to strengthen or widen the beam width of the beam pattern (S540).

The data-based lane change frequency in a road segment corresponding to the location information of the moving object 1000 is not relatively high, and thus the lamp control system 1 may be configured to determine that the location of the moving object 1000 is a region in which the beam width of the beam pattern is to be reduced (S550).

Accordingly, the lamp control system 1 may be configured to reduce or narrow the beam width of the beam pattern (S560).

FIG. 6 illustrates an example of a beam pattern with a controlled beam width according to the present disclosure.

In a system supporting an adaptive lamp mode, the beam pattern emitted by the lamp 700 may be adaptively controlled.

For example, the beam pattern may have a variable beam width. The beam width of the beam pattern may be varied depending on a degree of data-based lane change frequency at the location of the moving object 1000.

(a) of FIG. 6 shows a general beam pattern. (b) of FIG. 6 shows a beam pattern, an beam width of which is controlled (strengthened) to a first level. (c) of FIG. 6 shows a beam pattern, an beam width of which is controlled (strengthened) to a second level.

In an embodiment according to the present disclosure, an emitted beam pattern may be set to have an beam width that gradually increases as a data-based lane change frequency increases. Referring to FIG. 6, the beam pattern of (c) may be set to be emitted when a moving object drives on a road segment with a highest lane change frequency.

FIG. 6 illustrates a total of three beam patterns, but more or fewer beam patterns may be provided, and the beam patterns may be varied depending on a specific condition. It may be confirmed that only the beam width of the pattern in FIG. 6 is controlled while the visibility (distance) is maintained. This is to form a wide range of light distribution toward a road (lane) on left and right sides of the moving object 1000 or above the road (lane) when the moving object 1000 changes lanes. This may be an element that ensure a better view for a driver or user of the moving object 1000 or to notify the driver or user of surrounding moving objects of (a lane change).

However, unlike in FIG. 6, beam pattern control based on the “lane change frequency” of a road segment on which a moving object drives may perform control of not only an beam width but also an optical distance (i.e., beam distance). In this case, as the beam width of the beam pattern becomes wider, an beam distance may be controlled to become longer.

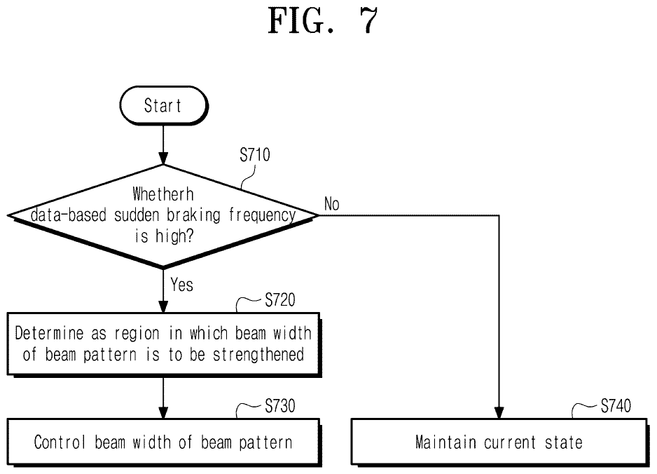

FIG. 7 illustrates a flowchart of a lamp control method according to the present disclosure.

The illustrated lamp control method may be performed by the lamp control system 1 or the moving object 1000 including the lamp control system 1. For simplicity of explanation, the illustrated method will be described as being performed by the lamp control system 1.

The lamp control system 1 may be configured to determine whether data-based sudden braking frequency is relatively high in a road segment corresponding to the location information of the moving object 1000 (S710).

The location information of the moving object 1000 may be obtained by the sensor 200, and the data-based sudden braking frequency may be obtained from information on the sudden braking frequency in the separate road segment described above or data obtained from analyzing and refining the information.

Whether the data-based sudden braking frequency is relatively high may be determined by comparing the sudden braking frequency on a road segment corresponding to the location information of the moving object 1000 with a preset reference.

As another example, instead of the sudden braking frequency, an input frequency of the output interface information for braking of the moving object may be used. The input frequency of the output interface information for braking may be information obtained based on detection of a control signal resulting from manipulation of a brake pedal of the moving object 1000.

Another piece of information may be used as a determination reference for controlling the lamp of FIG. 7.

The data-based sudden braking frequency (or the input frequency of output interface information for the braking) is relatively high in a road segment corresponding to the location information of the moving object 1000, and thus the lamp control system 1 may be configured to determine that the location of the moving object 1000 is a region in which the beam width of the lamp is to be strengthened (S720).

Accordingly, the lamp control system 1 may be configured to perform control of an beam width of the beam pattern (S730).

The data-based sudden braking frequency (or the input frequency of output interface information for the braking) is not relatively high in a road segment corresponding to the location information of the moving object 1000, and thus the lamp control system 1 may be configured to maintain the current state of the lamp (S740). That is, the lamp control system 1 may be configured to determine that the location of the moving object 1000 is a region that does not require additional control of an beam width of the beam pattern when the sudden braking frequency is not relatively high.

FIG. 8 illustrates an example of a beam pattern with controlled long-distance visibility and beam width according to the present disclosure.

In an adaptive lamp mode system, the beam pattern emitted by the lamp 700 may be adaptively controlled.

For example, the beam pattern may be varied in an irradiation distance and beam width. The long-distance visibility or beam width of the beam pattern may be varied depending on the data-based sudden braking frequency or a degree of a frequency of lighting a specific beam pattern at a location of the moving object 1000.

(a) of FIG. 8 shows a general beam pattern. (b) of FIG. 8 shows a beam pattern with long-distance visibility (irradiation distance) and beam width controlled (strengthened) to a first level. (c) of FIG. 8 shows a beam pattern with long-distance visibility (beam distance) and beam width controlled (strengthened) to a second level.

In an embodiment according to the present disclosure, an emitted beam pattern may be set to increase long-distance visibility and beam width that gradually increases as the data-based sudden braking frequency or the frequency of lighting a specific beam pattern increases. Referring to FIG. 8, the beam pattern of (c) may be set to be emitted when a moving object drives on a road segment with a highest sudden braking frequency or frequency of lighting the specific beam pattern.

FIG. 8 illustrates a total of three beam patterns, but more or fewer beam patterns may be provided, and the beam patterns may be varied depending on a specific condition.

As illustrated in FIG. 8, the reason for strengthening or controlling the long-distance visibility and beam width is to form a long and wide range of light distribution toward the road (lane) on left and right sides of the moving object 1000 or above the road (lane) when the moving object 1000 suddenly brakes or overtakes a preceding vehicle. This may be an element that ensure a better view for a driver or user of the moving object 1000 or to notify the driver or user of surrounding moving objects of (a lane change).

However, unlike in FIG. 8, beam pattern control based on the “sudden braking frequency” or the “frequency of lighting a specific beam pattern” of the road segment on which the moving object drives may perform control for either the beam width or the optical distance. In this case, the beam distance of the beam pattern may be controlled to become longer as the sudden braking frequency or a frequency of lighting the specific beam pattern increases.

FIG. 9 illustrates a flowchart of a lamp control method according to the present disclosure.

The illustrated lamp control method may be performed by the lamp control system 1 or the moving object 1000 including the lamp control system 1. For simplicity of explanation, the illustrated method will be described as being performed by the lamp control system 1.

The lamp control system 1 may be configured to perform initialization (S910). Initialization may include a procedure to check a system to ensure that the lamp control system operates properly.

The lamp control system 1 may detect whether the driver of the moving object 1000 attempts to overtake a moving object in front (S920). Detection of an overtaking attempt may be based on an input signal to an output interface for vehicle control of the moving object 1000, a manipulation signal of a turn signal lamp, or the like.

If no attempt to overtake the driver is detected, the method ends.

As an attempt to overtake by the driver is detected, the lamp control system 1 may obtain a relative speed and relative distance between the moving object 1000 and a moving object in front of the moving object 1000 and determine whether the obtained relative speed or relative distance satisfies a reference (S930).

For example, a speed of the moving object 1000 needs to be at least higher than that of a moving object in front of the moving object 1000, and thus a relative speed exceeding 0 may be used as the reference. Overtaking is possible when the relative distance between moving objects is within a certain distance, and thus the relative distance being within a certain distance may be used as the reference.

When a reference for the obtained relative speed or relative distance are not satisfied, the present disclosure is terminated.

As the reference for the obtained relative speed or relative distance are satisfied, the lamp control system 1 may obtain a frequency of use of a passing beam on a road segment on which the moving object 1000 drives and determine whether the obtained frequency of use of the passing beam exceeds a first reference frequency (S940). The first reference frequency may be a preset value.

As the obtained frequency of use of the passing beam exceeds the first reference frequency, the lamp control system 1 may be configured to set the beam pattern width of the lamp to a beam width control level 1 (S950). Accordingly, the lamp 700 may emit a beam pattern at beam width control level 1.

As the obtained frequency of use of the passing beam does not exceed the first reference frequency, the lamp control system 1 may determine whether the obtained frequency of use of the passing beam exceeds a second reference frequency (S960). The second reference frequency may be a preset value.

As the obtained frequency of use of the passing beam exceeds the second reference frequency, the lamp control system 1 may be configured to set the beam pattern width of the lamp to a beam width control level 2 (S970). Accordingly, the lamp 700 may emit a beam pattern at beam width control level 2.

As the obtained frequency of use of the passing beam does not exceed the second reference frequency, the lamp control system 1 may perform control to maintain an beam width of the beam pattern or switch the beam pattern to a general pattern (S980).

Unlike in the drawings, the obtained frequency of use of the passing beam does not exceed the second reference frequency, and thus the lamp control system 1 may again determine whether the obtained frequency of use of the passing beam exceeds a third reference frequency. That is, comparison may be performed between the obtained frequency of use of the passing beam and N reference frequencies (where N is an integer greater than or equal to 1). Even in this case, if the result of the comparison with an Nth reference frequency, that is, the frequency of use of the passing beam is less than or equal to the Nth reference frequency, the lamp control system 1 may perform control to maintain the beam width of the beam pattern or to switch the beam pattern to a general pattern.

In the method of FIG. 9, the “beam pattern beam width control level” may mean a level for controlling the size or level of the beam width or beam distance of the beam pattern.

In the method of FIG. 9, the first reference frequency may be set to be greater than the second reference frequency, and the Nth reference frequency may be set to be greater than the (N+1)th reference frequency. Beam width control level 1 may be set to a level in which the beam width or beam distance is strengthened (larger) than width control level 2, and beam width control level N may be set to a level in which the beam width or beam distance is strengthened (larger) than beam width control level N+1.

In this specification, data such as location-based driving data, a data-based lane change frequency, a data-based sudden braking frequency, or a frequency of use of the passing beam is not based on a usage history of only the moving object 1000, but correspond to data obtained by processing and collecting lane changes, sudden braking, or passing beam usage of all moving objects driving on the corresponding road segment (i.e., the entire road segment). Naturally, the moving object 1000 may not been done lane changes, sudden braking, or use of a passing beam on the corresponding road segment or may not have driven on the corresponding road segment.

The contents of the present disclosure described with reference to FIGS. 1 to 2 and FIGS. 4 to 9, which are not described with reference to FIG. 3, may be applied to the system 10 or the processor 610 thereof.

As another embodiment of the present disclosure, a lamp control system for beam pattern control is proposed using data refined by analyzing usage history data of a specific beam or usage history data of a specific beam.

Referring to FIG. 3, the memory 620 may store location-based usage history data of a specific beam pattern (e.g., high beam). Additionally or alternatively, the memory 620 may store data refined by analyzing the usage history data.

Before this, the lamp control system 10 may be configured to receive the location-based usage history data of the specific beam pattern from a server.

The location-based usage history data of the specific beam pattern may include data in which specific beam pattern lighting information and location information of a plurality of moving objects are linked. Here, the specific beam pattern lighting information may include output control signal information of a manipulator or a stalk (e.g., a multi-function switch) for lighting the specific beam pattern of the moving object, or lamp lighting information when an automatic lighting function based on illuminance is activated. The location information may include location information of a moving object corresponding to a time at which the output control signal information from the manipulator or the stalk is generated or detected, or location information of the moving object corresponding to a time at which a lamp lighting control signal of a lamp with an activated automatic lighting function is generated or detected.

That is, the server may collect and store or manage an output control signal for a manipulator or a stalk such as a multi-function switch for lighting a specific beam pattern of a plurality of moving objects and location information at a time when the output control signal obtained by a location information obtaining device such as a navigation (or GPS receiver) is detected. For example, the following data may be obtained.

TABLE 3

| | Frequency of lighting |
|---|---|
| | specific beam pattern |
| Location information | (relative index) |
| P1 | 90 |
| P2 | 97 |
| P3 | 7 |
| P4 | 15 |
| . . . | . . . |

Additionally or alternatively, the lamp control system 10 may be configured to receive data obtained by analyzing and refining the usage history data from the server.

The location-based usage history data of the specific beam pattern may include big data obtained by collecting and analyzing a usage history of the specific beam pattern of a plurality of moving objects based on location information. The server may form big data by collecting and analyzing use of the specific beam pattern of the plurality of moving objects and location information thereof. An example of big data regarding use of the location information-based use of a specific beam pattern according to the present disclosure is illustrated in FIG. 4.

As seen from FIG. 4, a frequency with which a specific beam pattern is used (lit) on the map is indicated by hatching. The information shown in FIG. 4 is obtained by collecting, analyzing, and refining a frequency of use of a specific beam pattern of a plurality of moving object and is indicated. A region (location) in which moving objects use a specific beam pattern a lot (or frequently) may be understood as an area in which lighting of a specific beam pattern is required due to a road condition or traffic volume. The present disclosure proposes to control activation of an adaptive lamp mode at a location in which a specific beam pattern is frequently lit, even if the driver or user of a mobile device does not separately operate lighting of a specific beam pattern.

The processor 610 may obtain location information of the moving object 1000. The location information of the moving object 1000 may be obtained by a sensor 200.

The processor 610 may be configured to control the lamp 700 by using the location information of the moving object 1000 and the usage history data of the specific beam pattern stored in the memory 620. In more detail, the processor 610 may be configured to control a beam pattern emitted by the lamp 700.

The processor 610 may be configured to activate an adaptive lamp mode when a frequency of lighting a specific beam pattern corresponding to the location information of the moving object 1000 indicated by the usage history data of the specific beam pattern stored in the memory 620 exceeds a preset reference.

Here, the preset reference may be expressed as a relative numerical value indicating, for example, a frequency of lighting a specific beam pattern for each region or location. Each region or location may be defined as a region having a certain area. As such, the processor 610 may be configured to activate an adaptive lamp mode when a lighting frequency value of a unit region in which the moving object 1000 is currently located exceeds a preset reference.

The processor 610 may be configured to deactivate the adaptive lamp mode when an off frequency indicated by usage history data of a specific beam pattern stored in the memory 620 exceeds a preset reference. Additionally or alternatively, the processor 610 may be configured to change an operating mode of the lamp. Here, the operating mode of the lamp may include a high beam assistance (HBA) mode or low beam mode. Additionally or alternatively, the processor 610 may be configured to change a parameter of the adaptive lamp mode. A change of the parameter in the adaptive lamp mode is described below with reference to FIG. 9.

The lamp control system 10 may further include the sensor 200 or 500. The sensor may include sensors 210, 220, 230, 240, 250, and 260 configured to obtain information related to driving of the moving object or sensors 510, 520, 530, and 540 configured to obtain surrounding information of the moving object. The current location information of the moving object 1000 may be obtained through the sensor. Location information of surrounding moving objects, such as a preceding vehicle or oncoming vehicle of the moving object 1000, may be obtained through the sensor.

The lamp control system 10 may further include the transceiver 800. The transceiver 800 may be configured to receive the location-based usage history data of the specific beam pattern from the server. The transceiver 800 may be configured to transmit, to the server, the location-based usage history data of the specific beam pattern of the moving object 1000 on which the lamp control system 10 is mounted or installed.

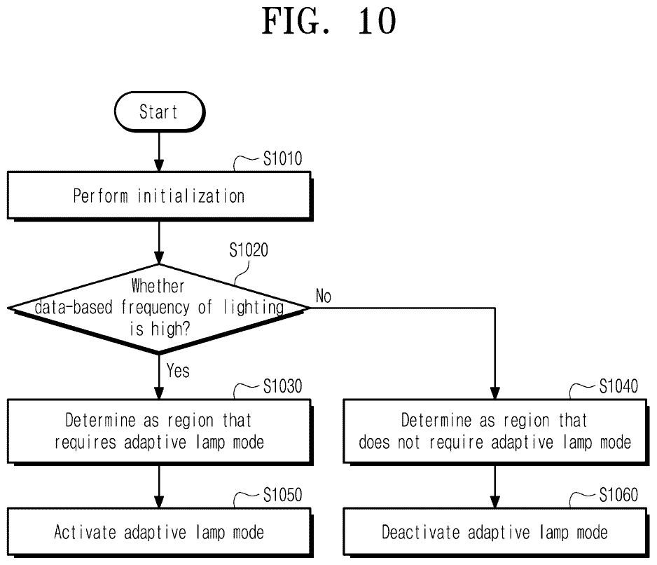

FIG. 10 illustrates a flowchart of a lamp control method according to the present disclosure. The illustrated lamp control method may be performed by the lamp control system 1 or the moving object 1000 including the lamp control system 1. For simplicity of explanation, the illustrated method will be described as being performed by the lamp control system 1.

The lamp control system 1 may be configured to perform initialization (S1010). Initialization may include a procedure to check a system to ensure that the lamp control system operates properly.

The lamp control system 1 may be configured to determine whether data-based frequency of lighting the specific beam pattern is relatively high in a region or location corresponding to the location information of the moving object 1000 (S1020).

The location information of the moving object 1000 may be obtained by the sensor 200, and the data-based frequency of lighting may be obtained from the location-based usage history data of the specific beam pattern described above or data obtained by analyzing and refining the information.

Whether data-based frequency of lighting the specific beam pattern is relatively high may be determined by comparing the frequency of lighting the specific beam pattern in a region or location corresponding to the location information of the moving object 1000 with a preset reference.

The data-based lighting frequency of the specific beam pattern is relatively high in a region or location corresponding to the location information of the moving object 1000, and thus the lamp control system 1 may be configured to determine that the location of the moving object 1000 is a region that requires the adaptive lamp mode (S1030).

The lamp control system 1 may be configured to activate the adaptive lamp mode (S1050).

According to another embodiment, other information may be used instead of the specific beam pattern lighting information. For example, as explained above, the number of times a lamp lighting control signal is generated or detected for a lamp with an activated automatic lighting function may replace a frequency of lighting.

The data-based lighting frequency of the specific beam pattern is not relatively high in a region or location corresponding to the location information of the moving object 1000, and thus the lamp control system 1 may be configured to determine that the location of the moving object 1000 is a region that does not require the adaptive lamp mode (S1040).

The lamp control system 1 may be configured to deactivate the adaptive lamp mode (S1060).

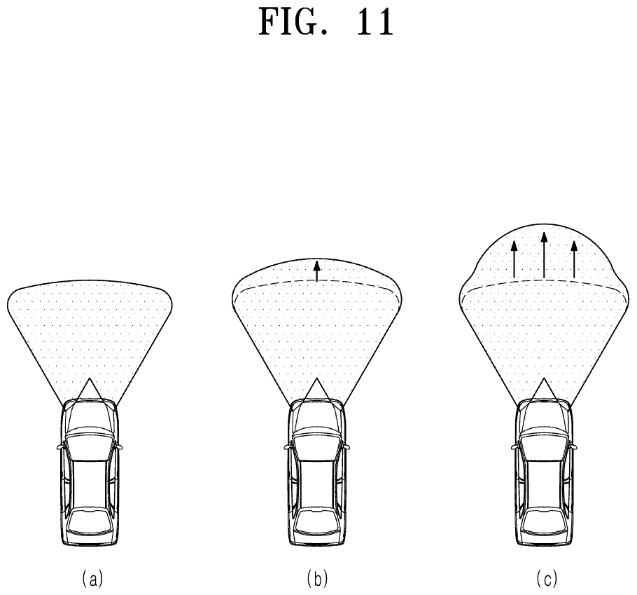

FIG. 11 illustrates an example of a beam pattern with controlled central brightness according to the present disclosure.

When the adaptive lamp mode is activated, the beam pattern emitted by the lamp 700 may be adaptively controlled.

For example, the beam pattern may have a variable central brightness. The central brightness may be varied depending on a degree of the data-based lighting frequency of the specific beam pattern at a location of the moving object 1000.

(a) of FIG. 11 shows a general beam pattern. (b) of FIG. 11 shows a beam pattern in which a central brightness is controlled (increased) to a first level. (c) of FIG. 11 shows a beam pattern in which a central brightness is controlled (increased) to a second level.

In an embodiment according to the present disclosure, an emitted beam pattern may be set to have a central brightness that gradually increases as a data-based lighting frequency of the specific beam pattern increases. Referring to FIG. 11, the beam pattern of (c) may be set to be emitted when a frequency of lighting is highest.

FIG. 11 illustrates a total of three beam patterns, but more or fewer beam patterns may be provided, and the beam patterns may be varied depending on a specific condition.

Activating the adaptive lamp mode may not necessarily result in the adaptive beam pattern being emitted. Irradiation of the adaptive beam pattern may be determined based on a condition for irradiation of a beam pattern, for example, illuminance, presence of a preceding vehicle, presence of an oncoming vehicle, or the like.

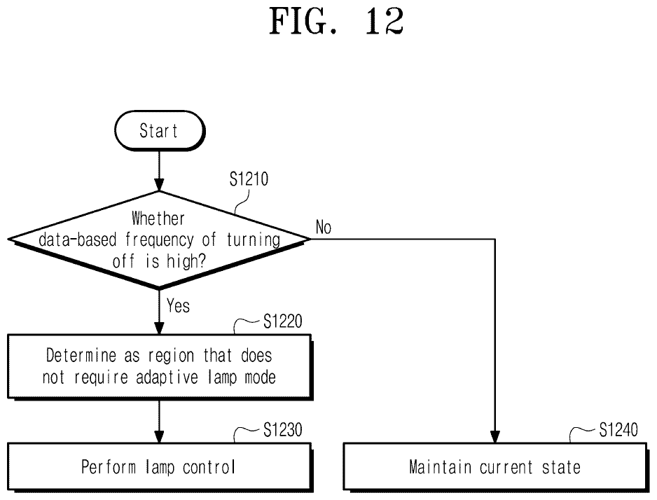

FIG. 12 illustrates a flowchart of a lamp control method according to the present disclosure.

The illustrated lamp control method may be performed by the lamp control system 1 or the moving object 1000 including the lamp control system 1. For simplicity of explanation, the illustrated method will be described as being performed by the lamp control system 1. FIG. 12, unlike FIG. 10, relates to turning off the lamp 700.

There are various reasons why “light off” is necessary, but it is necessary because the high beam may cause glare to a driver or user of the moving object 1000. Alternatively, shining of a high beam of the moving object 1000 may cause glare to a driver or user of other moving objects.

Beam cutting may occur due to shining of the high beam. Beam cutting due to reflection of light emitted by a lamp refers to a phenomenon in which light appears to be cut off or broken at a specific location when emitted by a headlamp of a moving object. This phenomenon mainly occurs in a system that precisely control distribution of light, such as an adaptive headlamp (ADB) or high-resolution matrix LED lamp.

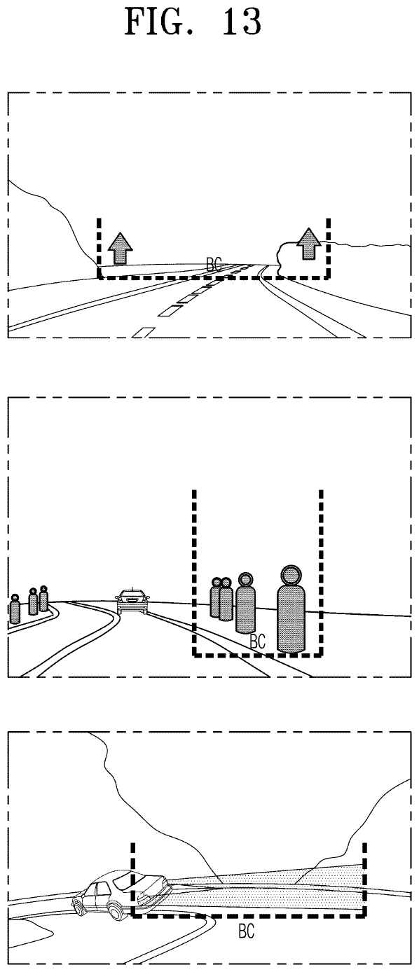

(a), (b), and (c) of FIG. 13 illustrate a beam cutting phenomenon caused by misrecognition of a reflector as an object, a beam cutting phenomenon caused by a sign flickering phenomenon in a construction area at night, and a beam cutting phenomenon on a curved road, respectively.

As this beam cutting phenomenon occurs, it is necessary to turn off the lamp 700. In FIG. 13, a portion marked BC represents a region in which a lamp is turned off due to the beam cutting phenomenon.

The lamp control system 1 may be configured to determine whether data-based frequency of turning off the specific beam pattern is relatively high in a region or location corresponding to the location information of the moving object 1000 (S1210).

The location information of the moving object 1000 may be obtained by the sensor 200, and the data-based frequency of turning off may be obtained from the location-based usage history data of the specific beam pattern described above or data obtained by analyzing and refining the information.

Whether data-based frequency of turning off the specific beam pattern is relatively high may be determined by comparing the frequency of turning off the specific beam pattern in a region or location corresponding to the location information of the moving object 1000 with a preset reference.

According to another embodiment, instead of a frequency of turning off a specific beam pattern, a frequency of input of a control signal for releasing the adaptive lamp mode may be used. The input of the control signal may be performed by manipulation of a user or driver on a multi-function switch, button, virtual button, or the like of the moving object 1000.

Another piece of information may be used as a determination reference for control of the adaptive lamp mode or lamp control of FIG. 12.

A frequency of turning off a specific beam pattern based on data (or a frequency of inputting a control signal for releasing the adaptive lamp mode) in a region or location corresponding to the location information of the moving object 1000 is relatively high, and thus the lamp control system 1 may be configured to determine that the location of the moving object 1000 is a region that does not require the adaptive lamp mode (S1220).

Accordingly, the lamp control system 1 may be configured to perform lamp control (S1230).

Here, lamp control may include changing an operating mode of the lamp 700. For example, if the procedure of FIG. 12 is performed after S1050 of FIG. 10, the lamp control may include deactivating the adaptive lamp mode and activating another lamp mode. An example of another lamp mode may include a high beam assistance (HBA) mode or low beam mode.

Additionally or alternatively, the lamp control may include changing a parameter of the adaptive lamp mode. For example, changing the parameters of the adaptive lamp mode may include extending or lengthening a time interval for recognizing two tail lamps (or light sources) of a preceding vehicle as information for recognizing the preceding vehicle.

When a preceding vehicle is recognized, the beam pattern needs not be emitted to a region in which the preceding vehicle is located, and thus a beam for the region may be controlled to be turned off. The beam pattern may be controlled to be emitted to a region in which the preceding vehicle is not recognized.

However, as a flicker phenomenon, that is, a phenomenon in which one of the two tail lamps (or light sources) of the front moving objects is recognized or detected by reflection from irradiation of the lamp of the moving object 1000 and not recognized or detected, is repeated, irradiation of the lamp of the moving object 1000 may be repeatedly turned on and off instantaneously.

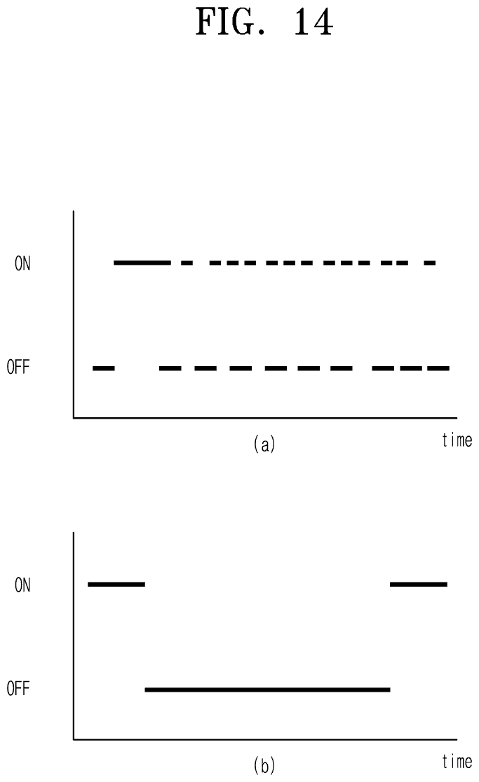

For example, referring to FIG. 14, as in (a) of FIG. 14, on and off status of the lamp may be switched instantaneously. This may not only cause dazzling to front moving object, but may also obstruct a view of the driver or user of the front moving object or moving object 1000.

To reduce this phenomenon, a method is proposed to delay a reaction rather than immediately reacting to the recognition result of the detected front moving object, as in (b) of FIG. 14. That is, the processor 610 may be configured to average and calculate results of recognition or non-recognition of the tail lamp of the front moving object through the sensor 500 of the moving object 1000, i.e., the camera, over a preset period of time. For example, the processor 610 may sample a recognition result as 0 and a non-recognition result as 1, average the sampling values of the recognition or non-recognition results obtained over a preset period of time, and determine the final result as “recognition” if the result exceeds a preset value (e.g., 0.7) and determine the result as “non-recognition” if the result is lower than the preset value.

As another example, the processor 610 may periodically obtain the results of recognition or non-recognition of the tail lamp of the front moving object, accumulate the results by using a counter, and control the lamp 700 only when a certain number of consecutive detection results occur.

The data-based turning-off frequency of the specific beam pattern is not relatively high in a region or location corresponding to the location information of the moving object 1000, and thus the lamp control system 1 may be configured to maintain the current state of the lamp (S1240). That is, the lamp control system 1 may be configured to determine that the location of the moving object 1000 is a region that requires the adaptive lamp mode when a frequency of turning off the specific beam pattern is not relatively high.

In this specification, data such as the location-based usage history data of the specific beam pattern, a data-based frequency of lighting, or a data-based frequency of turning off may not be based on usage, lighting, or off history of only the moving object 1000, but corresponds to data processed by collecting usage, lighting, or off of a specific beam pattern of all moving objects that drove in the corresponding location (i.e., the entire road segment). Naturally, the moving object 1000 may never have used, or turned on or off a specific beam pattern at the corresponding location or may never have driven on a road segment corresponding to the corresponding location.

The contents of the present disclosure described with reference to FIGS. 4, and 10 to 14, which are not described with reference to FIG. 3, may be applied to the system 10 or the processor 610 thereof.

As another embodiment of the present disclosure, the moving object or vehicle 1000 including the lamp control system 10 described above is proposed.

The present disclosure has the following effects.

The present disclosure may provide lamp control based on data reflecting a driving environment of a road segment on which a moving object drives, thereby not requiring a user or driver to manipulate a multi-function switch, and thus may provide an environment in which visibility may be improved while driving.

The present disclosure provides an environment in which visibility during night driving may be improved by adjusting an beam width or beam distance of a beam pattern in proportion to a data-based lane change frequency, a sudden braking frequency, or a frequency of use of a specific beam pattern, and may further improve long-distance visibility.

The present disclosure may provide an environment in which visibility during night driving may be improved by adjusting the brightness of a beam pattern in proportion to a data-based frequency of lighting when activating an adaptive lamp mode, and may further improve long-distance visibility.

The effects of the present disclosure are not limited to the effects described above. Other effects not described above may be understood by those skilled in the art from the description of the present disclosure below.

In the above specification, the “system” for controlling a lamp or each component included therein is described as performing control, but the “device”, “system” and the components included therein are only names and the scope of rights is not dependent on thereon.

In other words, the proposed technology of the present disclosure may be performed by devices having names other than the processor, controller, etc. In addition, the method, scheme, or the like described above may be performed by software or code readable by a computer or other machine or device for lamp control.

In addition, as another aspect of the present disclosure, the operation of the proposed technology described above may be provided as code that may be implemented, realized, or executed by a “computer” concept (a generic including a system on chip (SoC) or a (micro) processor) or a computer-readable storage medium, a computer program product, or the like storing or containing the code. The scope of the present disclosure is extendable to the code or the computer-readable storage medium or the computer program product storing or containing the code.

Detailed descriptions of preferred embodiments of the present disclosure disclosed as described above have been provided such that those skilled in the art may implement and realize the present disclosure.

Although the present disclosure has been described above with reference to preferred embodiments, those skilled in the art will understand that various modifications and changes can be made to the present disclosure set forth in the claims below.

Accordingly, the present disclosure is not intended to be limited to the embodiments shown herein but is to be accorded the widest scope consistent with the principles and novel features disclosed herein.

As is apparent from the above description, the method and apparatus according to the embodiments of the present disclosure have the following effects.

The embodiments of the present disclosure can detect diffuse reflection noise in ultrasonic sensor data.

In addition, the embodiments of the present disclosure can ignore or remove sensor data from which diffuse reflection noise is detected, thereby preventing the false braking phenomenon due to false recognition of an obstacle.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the appended claims and their equivalents.

What is claimed is:

1. A lamp control system for a moving object, the lamp control system comprising:
a lamp configured to emit a beam pattern, among a plurality of beam patterns, toward a front of the moving object;
a memory for storing location-based driving data or data obtained by analyzing and refining the location-based driving data; and
a processor configured to control the beam pattern based on the data stored in the memory and location information of the moving object.

2. The lamp control system of claim 1, wherein the processor is further configured to control the lamp to strengthen a beam width of the beam pattern based on a lane change frequency of the driving data corresponding to the location information of the moving object exceeding a preset reference.

3. The lamp control system of claim 2, wherein the processor is further configured to emit a beam pattern having a beam width that increases in proportion to the lane change frequency.

4. The lamp control system of claim 1, wherein the processor is further configured to control the lamp to reduce a beam width of the beam pattern based on a lane change frequency of the driving data corresponding to the location information of the moving object being lower than a preset reference.

5. The lamp control system of claim 1, wherein the processor is further configured to control the lamp to strengthen a beam distance or a beam width of the beam pattern based on a sudden braking frequency of the driving data corresponding to the location information of the moving object exceeding a preset reference.

6. The lamp control system of claim 5, wherein the processor is further configured to emit a beam pattern having a beam distance or a beam width that increases in proportion to the sudden braking frequency.

7. The lamp control system of claim 1, wherein the processor is further configured to:
determine whether the moving object intends to overtake a preceding vehicle based on driving data of the moving object; and
control the lamp to emit a specific beam pattern based on location-based usage history data of the specific beam pattern and the location information of the moving object.

8. The lamp control system of claim 7, wherein the processor is further configured to control the lamp to emit a beam pattern having a beam distance or a beam width that increases in proportion to a frequency of usage of the specific beam patten.

9. The lamp control system of claim 1, wherein the data obtained by analyzing and refining the location-based driving data or the driving data includes data obtained by collecting and processing data on a lane change frequency on a separate road segment, a sudden braking frequency on the separate road segment, or a frequency of use of a specific beam pattern on the separate road segment of a plurality of moving objects based on information on the separate road segment or location information.

10. The lamp control system of claim 1, wherein the processor is further configured to additionally use at least one of navigation information, advanced driver assistance system related information, or vehicle control output interface information, for controlling the beam pattern.

11. A lamp control system for a moving object, the lamp control system comprising:
a lamp configured to emit a beam pattern, among a plurality of beam patterns, toward a front of the moving object;
a memory for storing data obtained by analyzing and refining location-based usage history data of a specific beam pattern or usage history data of the specific beam pattern; and
a processor configured to control the beam pattern based on the data stored in the memory and location information of the moving object.

12. The lamp control system of claim 11, wherein the processor is further configured to activate an adaptive lamp mode based on a frequency of lighting of the specific beam pattern corresponding to the location information of the moving object indicated by the data exceeding a preset reference.

13. The lamp control system of claim 12, wherein the processor is further configured to emit a beam pattern having a central brightness that increases in proportion to the frequency of lighting.

14. The lamp control system of claim 12, wherein the processor is further configured to deactivate the adaptive lamp mode, change an operating mode of the lamp, or change a parameter of the adaptive lamp mode based on a frequency of turning off the specific beam pattern corresponding to the location information of the moving object indicated by the data exceeding a preset reference.

15. The lamp control system of claim 14, wherein the operating mode of the lamp includes a high beam assistance mode or a low beam mode.

16. The lamp control system of claim 14, wherein the processor is further configured to average and calculate a result of recognition or non-recognition of a tail lamp of a preceding vehicle over a preset period of time through a camera of the moving object.

17. The lamp control system of claim 16, wherein the processor is further configured to control the lamp according to the result of recognition or non-recognition of the tail lamp of the preceding vehicle.

18. The lamp control system of claim 11, wherein the location-based usage history data of the specific beam pattern includes data linked to operation information of a stalk for lighting the specific beam pattern and location information of a navigation of a plurality of moving objects.

19. The lamp control system of claim 11, wherein the data obtained by analyzing and refining the location-based usage history data of the specific beam pattern includes big data obtained by collecting and analyzing a usage history of the specific beam pattern of a plurality of moving objects based on location information.

20. A lamp control method for a moving object, performed by a lamp control system including a lamp configured to emit a beam pattern toward a front of the moving object, the lamp control method comprising:
obtaining location information of the moving object;
extracting data obtained from location-based driving data or by analyzing and refining the location-based driving data; and
controlling the beam pattern based on the extracted data and location information of the moving object.
